(19) United States
(12) Patent Application Publication
(10) Pub. No.: US 2012/0142533 A1
(43) Pub. Date: Jun. 7, 2012

(54) REDUCED VAPORIZATION COMPOSITIONS AND METHODS

(75) Inventors: Thomas J. Richard, St. Louis, MO (US); Keith R. Rowley, Madison, WI (US)

(73) Assignee: ACCUFORM TECHNOLOGIES, LLC, Middleton, WI (US)

(21) Appl. No.: 13/378,624

(22) PCT Filed: Jun. 15, 2010
(86) PCT No.: PCT/US2010/038646

§ 371 Date: Feb. 20, 2012

Related U.S. Application Data
(60) Provisional application No. 61/187,054, filed on Jun. 15, 2009.

(51) Int. Cl. A01N 43/80; A01N 25/02; A01P 13/00; A01N 25/16; A01P 3/00; A01P 21/00; A01N 25/04; A01N 57/12; A01P 7/04

(52) U.S. Cl. 504/271; 514/122; 504/362; 504/363; 514/783; 514/772; 514/786

(57) ABSTRACT

The present invention provides compositions, systems, and methods employing materials to reduce or eliminate vapor transfer of an active substance from a target surface to a non-target surface. In certain embodiments, a material is mixed with a liquid, gas, and/or solid comprising an active substance to form a mixture such that the mixture has a lower vapor pressure than the liquid, gas, and/or solid. In some embodiments, the active substance is a herbicide and the target surface is an agricultural field or crop.

The present application claims priority to U.S. Provisional Patent Application Ser. No. 61/187,054, filed Jun. 15, 2009, the entire disclosure of which is herein incorporated by reference in its entirety.

### FIELD OF THE INVENTION

The present invention relates to compositions, systems, and methods employing materials that reduce or eliminate vapor transfer of an active substance from a target surface to a non-target surface. In certain embodiments, a material is mixed with a liquid, gas, and/or solid comprising an active substance to form a mixture such that the mixture has a lower vapor pressure than the liquid, gas, and/or solid. In some embodiments, the active substance is a herbicide and the target surface is an agricultural field or crop.

### BACKGROUND

Herbicides such as 2,4-D amine, clomazone, dicamba are significantly volatile, and conventional emulsion concentrates of this material, when applied to soil in a target crop area, may exhibit vapor transfer induced drift characteristics typically resulting in a degree of crop injury, epinasty, whitening or bleaching, of non-targeted crops, trees and/or decorative areas. Such adjacent area damage is extremely undesirable. For this reason, the label for the use of 2,4-D, an emulsifiable concentrate formulation in commercial use that contains four pounds of dimethylamine salt of 2,4-dichlorophenoxyacetic acid per gallon of formulation and, COMMAND 4 EC herbicide, an emulsifiable concentrate formulation in commercial use that contains four pounds of clomazone per gallon of formulation, lists a number of restrictions on how the product is to be used, including weather conditions, spray volume and pressure, and distance from areas where plants/fields/orchards are in commercial production. For example, for pre-emergent applications, clomazone application cannot be made within 1,500 feet of commercial fruit, nut, or vegetable production or commercial greenhouses or nurseries. Clearly, this is a severe limitation on the use of a herbicide. Because of this type of limitation, workers in the art have attempted to either micro-encapsulate clomazone (Stern, U.S. Pat. No. 5,583,090; Len Lee, U.S. Pat. No. 5,597,780; Anderson, U.S. Pat. No. 5,783,520; all of which are herein incorporated by reference in their entireties) or incorporate clomazone into solids prior to soil application (James Essinger, U.S. Pat. No. 5,665,678, herein incorporated by reference in its entirety). As a result of these efforts, the most popular formulation of clomazone currently being marketed in the US is no longer the aforementioned emulsifiable concentrate, COMMAND 4EC, but rather COMMAND 3ME, which is a microencapsulated product containing three pounds of clomazone per gallon based on polymer technology. Such formulation approaches, while somewhat successful in preventing vapor transfer of clomazone, involve added cost in the form of expensive materials for emulsion polymerization and processing costs while reducing efficacy of the product relative to a standard emulsion concentrate, as exemplified by the bioefficacy data of U.S. Pat. No. 5,583,090. The reason for the reduced efficacy is the entrapment of clomazone in microcapsules. Microcapsules do not allow straightforward diffusion controlled release to the target site, but require additional permeation though whatever material is chosen as the microcapsule wall, typically a polyurea or polyisocyanate. What is needed are formulations that do not rely on microencapsulation or other entrapment systems but still have reduced or no vapor transfer of active substances.

### SUMMARY OF THE INVENTION

The present invention provides compositions, systems, and methods employing materials (e.g., solvents) to reduce or eliminate vapor transfer (vapor drift) of an active substance from a target surface to a non-target surface. In certain embodiments, a material (e.g., solvent) is mixed with a liquid, gas and/or solid comprising an active substance to form a mixture such that the mixture has a lower vapor pressure than the liquid, gas, and/or solid. In some embodiments, the active substance is a herbicide and the target surface is an agricultural field or crop. In some embodiments, the active substance is pre-mixed with one or more co-solvents or other materials (e.g., solid or liquid materials) before the addition of the vapor controlling material (e.g., solvent). The active substance may also be co-formulated with one or more additional desired substances. The invention is not limited by the natures of the active substance. In some embodiments, the active substance is any one or more agriculturally active substances (e.g., herbicides, insecticides, plant growth regulators, pesticides, fungicides, etc.).

Agriculturally active substances can be used in a wide variety of applications, including, but not limited to, farming, total vegetative control in pasture, rangeland, and forestry, pest control in any desired environment (e.g., mosquito control), aquaculture, turf and ornamental applications, repellents (e.g., deer repellents), and the like.

In some embodiments, the present invention provides compositions comprising, consisting essentially of, or consisting of a mixture of: i) a solvent or other material (e.g., solid, liquid, or gas), and ii) a liquid, gas or solid comprising an active substance (e.g., a herbicidal active substance), wherein the liquid/gas or solid has a first vapor pressure at a particular temperature when not mixed with the solvent or material, and wherein the mixture has a second vapor pressure at the particular temperature that is lower than the first vapor pressure.

In certain embodiments, the present invention provides compositions comprising, consisting essentially of, or consisting of: i) a liquid, gas and/or solid comprising an active substance (e.g., a herbicidal active substance), and ii) a solvent or other material, wherein the solvent or other material reduces or eliminates vapor transfer of the active substance at a particular temperature from a first surface to a second surface, and wherein vapor transfer of the active substance to the second surface would occur (e.g., at a higher level) in the absence of the solvent or other material.

In particular embodiments, the first surface comprises: i) an agricultural crop not killed or injured by the composition, and ii) undesirable plants killed or injured by the composition. In further embodiments, the second surface comprises desirable agricultural crops injured or killed by the active substance in the composition. In some embodiments, the first surface is an agricultural field. The present invention is not limited by the first surface, which can be any surface, such as a surface where air quality above and around the surface is important (e.g., important to keep an active substance from vaporizing to a significant degree and moving to a non-target site).

In some embodiments, the first surface comprises first plants harboring a type of insect injurious to the first plants, and the second surface comprises second plants harboring the same type of insects, wherein the same type of insects are non-injurious or beneficial to said second plants. In certain embodiments, the first plants are first type of crop (e.g., corn, soybean, wheat, etc.) and said second plants are a different type of crop than said first type of crop (e.g., the first cope is corn and the second crop is soybeans).

In other embodiments, the present invention provides compositions comprising, consisting essentially of, or consisting of: i) a liquid, gas and/or solid comprising an active substance (e.g., herbicide, insecticide, etc), and ii) a solvent comprising: a) about 49-53% linoleic acid, b) about 21-25% oleic acid, c) about 5-9% linolenic acid, d) about 2-6% stearic acid, and e) about 8-12% palmitic acid; wherein the composition is free or substantially free of microcapsules or reagents used to form microcapsules or porous carrier particles. In some embodiments, fatty acids reside in triglycerides or other molecules comprising two or more fatty acid chains.

In particular embodiments, the present invention provides compositions comprising, consisting essentially of, or consisting of: i) a liquid comprising 2,4-D (or derivative thereof), clomazone (or active derivative thereof), dimethoate, chlorpyrifos, dicamba, or malathion (or active derivative thereof), and ii) a solvent comprising: a) about 49-53% linoleic acid, b) about 21-25% oleic acid, c) about 5-9% linolenic acid, d) about 2-6% stearic acid, and e) about 8-12% palmitic acid; wherein the composition is free or substantially free of microcapsules or reagents used to form microcapsules.

In some embodiments, the solvent comprises soybean oil. In other embodiments, the compositions further comprise water. In additional embodiments, the liquid and the solvent are present in approximately equal percentages by weight in the composition (e.g., 1:1; 1.1:0.9; or 1.2:0.8). In other embodiments, about 5-20% or about 8-15% of the composition by weight is the solvent (e.g., 5% . . . 10% . . . 15 . . . or 20%).

In certain embodiments, the solvent or other material reduces or eliminates vapor transfer of the active substance at the particular temperature from a first surface to a second surface, and wherein vapor transfer of the active substance to the second surface would occur in the absence of the solvent. In further embodiments, the first surface comprises: i) an agricultural crop not killed or injured by the composition, and ii) undesirable plants killed or injured by the composition. In other embodiments, the second surface comprises desirable agricultural crops injured or killed by the active substance in the composition.

In other embodiments, the compositions further comprise water. In additional embodiments, the compositions further comprise an emulsifier (e.g., a surfactant, lecithin, salts of ligninsulfonic acid, Toximul 8242, Toximul TA-5, and Atlox 4838B). In other embodiments, the mixture is an emulsion (i.e., the liquid and the solvent are mixed together in the form of an emulsion). In further embodiments, the mixture is an emulsifiable concentrate (i.e., liquid and the solvent are mixed together in the form of an emulsifiable concentrate). In particular embodiments, the mixture is a simple solution. In additional embodiments, the liquid and the solvent are mixed together in the form of a foam. In some embodiments, the liquid and the solvent are mixed together in the form of a microemulsion. In certain embodiments, the solvent has a lower vapor pressure than the first vapor pressure of the liquid. In particular embodiments, the solvent has a vapor pressure that is at least two times lower than the first vapor pressure of the liquid (e.g., two, three, four, five . . . ten . . . 20 . . . 30 . . . 40 . . . 50 . . . 100 . . . 1000 times lower).

In some embodiments, the solvent comprises triglycerides. In other embodiments, the solvent comprises poly un-saturated fatty acids, mono-unsaturated fatty acids, and saturated fatty acids. In certain embodiments, the solvent comprises: i) about 50-65% poly un-saturated fatty acids (e.g., 50% . . . 55% . . . 60% . . . or 65%), ii) about 18-30% mono-unsaturated fatty acids (e.g., 18% . . . 25% . . . or 30%), and iii) about 10-20% saturated fatty acids (e.g., 10% . . . 15% . . . or 20%). In other embodiments, the solvent comprises: i) about 55-60% poly un-saturated fatty acids, ii) about 20-25% mono-unsaturated fatty acids, and iii) about 12-17% saturated fatty acids. In particular embodiments, the solvent comprises about 57.9% poly un-saturated fatty acids, about 23.3% mono-unsaturated fatty acids, and about 14.4% saturated fatty acids. In further embodiments, the solvent comprises: i) about 45-55% linoleic acid (e.g., 45% . . . 50% . . . or 55%), ii) about 20-30% oleic acid (e.g., 20% . . . 25% . . . or 30%), iii) about 3-10% linolenic acid (e.g., 3% . . . 5% . . . or 10%), iv) about 1-8% stearic acid (e.g., 1% . . . 5% . . . or 8%), and v) about 5-15% palmitic acid (e.g., 5% . . . 10% . . . or 15%). In certain embodiments, the solvent comprises: i) about 49-53% linoleic acid, ii) about 21-25% oleic acid, iii) about 5-9% linolenic acid, iv) about 2-6% stearic acid, and v) about 8-12% palmitic acid. In particular embodiments, the solvent comprises about 51% linoleic acid, about 23% oleic acid, about 7% linolenic acid, about 4% stearic acid, and about 10% palmitic acid.

In some embodiments, the solvent is a solid at room temperature (i.e., 20 to 25° C.).

In particular embodiments, the solvent comprises paraffin oil, an edible oil, vegetable oil, soybean oil, or an animal oil. In some embodiments, the solvent is a liquid in which the liquid (containing the active substance) is soluble at temperatures below the decomposition point of the liquid (containing the active substance). In particular embodiments, the solvent is a mineral oil or is a petrolatum. In certain embodiments, the solvent is selected from the group consisting of: almond oil, argan oil, avocado oil, canola oil, cashew oil, castor oil, coconut oil, colza oil, corn oil, cottonseed oil, grape seed oil, hazelnut oil, hemp oil, linseed oil (flaxseed oil), macadamia oil, manila oil, mongongo nut oil, mustard oil, olive oil, palm oil (palm kernel oil), peanut oil, pecan oil, perilla oil, pine nut oil, pistachio oil, poppyseed oil, pumpkin seed oil, rapeseed oil, rice bran oil, safflower oil, sesame oil, soybean oil, sunflower oil, tea seed oil, walnut oil, watermelon seed oil, and any combination thereof.

In some embodiments, the material mixed with the active substance to lower the vapor pressure of the active substance is a solid material. In some such embodiments, the active substance is mixed with the solid material to produce a mixture. In some embodiments, the mixture is prepared (e.g., crushed, ground, etc.) to a power form. In some embodiments, the solid material may be a solvent. In other embodiments, the solid material is not a solvent or does not solvate the active substance. In some embodiments, the solid material may be in the molten state during incorporation of the active substance.

In some embodiments, the liquid comprising the active substance is volatile. In other embodiments, the active substance in the liquid comprises a herbicide (e.g., clomazone, MCPA, dicamba, propanil; members of the thiocarbamate family, EPTC (ERADICANE, EPTAM) and buylate (SUTAN+); the dinitroanalines, trifluraline (TREFLAN) and ethalfluralin (SONALAN); mecoprop, dichlorprop, and dicamba). In certain embodiments, the active substance in the liquid is a volatile herbicide or volatile pesticide. In some embodiments, the active substance is selected from the group consisting of: acetochlor, alachlor, asulam, butachlor, diethatyl, diflufenican, dimethenamid, flamprop, metazachlor, metolachlor, pendimethalin, pretilachlor, propachlor, propanil, trifluralin, aminopyralid, chloramben, clopyralid, dicamba, picloram, pyrithiobac, quinclorac, quinmerac, cacodylic acid, copper arsenate, DSMA, MSMA, bensulide, bilanafos, ethephon, fosamine, glufosinate, glyphosate, piperophos, 2,4-D, 2,4-DB, dichlorprop, fenoprop, MCPA, MCPB, 2,4,5-T, dithiopyr, fluoroxypyr, imazapyr, thiazopyr, triclopyr, diquat, MPP, paraquat, ametryn, atrazine, cyanazine, hexazinone, prometon, prometryn, propazine, simazine, simetryn, terbuthylazine, terbutryn, chlortoluron, DCMU, metsulfuron-methyl, 3-AT, bromoxynil, clomazone, DCBN, dinoseb, juglone, methazole, metham sodium, and sulfentrazone. In particular embodiments, the active substance is a herbicide identified as prone to vapor drift by a green house assay, such as the one described in Example 7. In certain embodiments, the active substance is any compound that has a higher vapor pressure than the solvent (e.g., any compound where is would be useful to prevent vapor drift or useful to prevent vaporization such that humans and animals avoid breathing or smelling the compound).

In certain embodiments, the mixture allows vapor transfer of the herbicide at a level equivalent to, or less than, the level of vapor transfer of clomazone by COMMAND 3ME (e.g., as determined by a greenhouse or field test). In particular embodiments, the mixture allows vapor transfer of the herbicide at level that is commercially meaningful, whether or not it allows a similar level of vapor transfer of clomazone (or other herbicide) by COMMAND 3ME. For example, the mixture achieves the intended commercial result when used in a farm fields and can be successfully used under the same conditions as COMMAND 3ME (e.g., same temperatures, or wind conditions, or with the same spraying implements, etc.). Such commercially similar result may be a somewhat less effective result than COMMAND 3ME, but still useful enough to be used in commercial practice.

In certain embodiments, the active substance in the liquid comprises 2,4-Dichlorophenoxyacetic acid (or derivative thereof), dicamba, or alachlor (other chloroacetamides, or derivative thereof). In other embodiments, the active substance in the liquid comprises clomazone or a clomazone derivative. In certain embodiments, the active substance in the liquid comprises malathion or a malathion derivative, dimethoate, and/or chlorpyrifos. In particular embodiments, the active substance in the liquid comprises a pesticide (e.g., insecticide, fungicide, plant growth regulator). In other embodiments, the active substance in the liquid comprises dimethoate or derivative thereof. In further embodiments, the active substance in the liquid comprises a pharmaceutical or an offensive smelling compound. In certain embodiments, the mixtures of the present invention are used to generate control release drug formulations. In other embodiments, the active substance is an industrial cleaner and the mixtures of the present invention help reduce or eliminate noxious odors and fumes. In other embodiments, the active substance is a compound used in manufacturing that contributes to poor air quality at a manufacturing facility. In further embodiments, the active substance is one that requires transport without vapor transfer during transport (e.g., methypropane). In further embodiments, the active substance in the liquid is selected from the group consisting of: a herbicide, an insecticide, a fungicide, a fertilizer, a plant growth regulator, an insect growth regulator, and a bio-pesticide, an adjuvant, and a surfactant. In certain embodiments, the liquid further comprises one or more additional active substances.

In some embodiments, the active substance is a pesticide. Pesticide categories include, but are not limited to, acaricides, avicides, chemosterilants, herbicides, insecticides, molluscicides, plant growth regulators, virucides, algicides, bactericides, fungicides, insect attractants, mammal repellents, nematicides, rodenticides, antifeedants, bird repellents, herbicide safeners, insect repellents, mating disrupters, plant activators, synergists, chemical classes, and miscellaneous.

In some embodiments, the active substance is an insecticide. Insecticides include, but are not limited to, antibiotic insecticides (e.g., allosamidin, thuringiensin); macrocyclic lactone insecticides (e.g., avermectin insecticides (e.g., abamectin, doramectin, emamectin, eprinomectin, ivermectin, selamectin), milbemycin insecticides (e.g., lepimectin, milbemectin, milbemycin oxime, and moxidectin), spinosyn insecticides (e.g., spinetoram and spinosad)); arsenical insecticides (e.g., calcium arsenate, copper acetoarsenite, copper arsenate, lead arsenate, potassium arsenite, sodium arsenite); botanical insecticides (e.g., allicin, anabasine, azadirachtin, carvacrol, d-limonene, matrine, nicotine, nornicotine, oxymatrine, pyrethrins (e.g., cinerins, (e.g., cinerin I, cinerin II), jasmolin I, jasmolin II, pyrethrin I, pyrethrin II), quassia, rhodojaponin-III, rotenone, ryania, sabadilla, triptolide); carbamate insecticides (e.g., bendiocarb, carbaryl); benzofuranyl methylcarbamate insecticides (e.g., benfuracarb, carbofuran, carbosulfan, decarbofuran, furathiocarb), dimethylcarbamate insecticides (e.g., dimetan, dimetilan, hyquincarb, isolan, pirimicarb, pyramat); oxime carbamate insecticides (e.g., alanycarb, aldicarb, aldoxycarb, butocarboxim, butoxycarboxim, methomyl, nitrilacarb, oxamyl, tazimcarb, thiocarboxime, thiodicarb, thiofanox); phenyl methylcarbamate insecticides (e.g., allyxycarb, aminocarb, bufencarb, butacarb, carbanolate, cloethocarb, CPMC, dicresyl, dimethacarb, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb); desiccant insecticides (e.g., boric acid, diatomaceous earth, silica gel); diamide insecticides (e.g., chlorantraniliprole, cyantraniliprole, flubendiamide); dinitrophenol insecticides (e.g., dinex, dinoprop, dinosam, DNOC); fluorine insecticides (e.g., barium hexafluorosilicate, cryolite, flursulamid, sodium fluoride, sodium hexafluorosilicate, sulfluramid); formamidine insecticides (e.g., amitraz, chlordimeform, formetanate, formparanate, medimeform, semiamitraz); fumigant insecticides (e.g., acrylonitrile, carbon disulfide, carbon tetrachloride, chloroform, chloropicrin, para-dichlorobenzene, 1,2-dichloropropane, dithioether, ethyl formate, ethylene dibromide, ethylene dichloride, ethylene oxide, hydrogen cyanide, methyl bromide, methyl iodide, methylchloroform, methylene chloride, naphthalene, phosphine, sulfuryl fluoride, tetrachloroethane); inorganic insecticides (e.g., borax, boric acid, calcium polysulfide, copper oleate, diatomaceous earth, mercurous chloride, potassium thiocyanate, silica gel, sodium thiocyanate, see also arsenical insecticides, see also fluorine insecticides); insect growth regulators (e.g., chitin synthesis inhibitors (e.g., bistrifluoron, buprofezin, chlorbenzuron, chlorfluazuron, cyromazine, dichlorbenzuron, diflubenzuron, flucycloxuron, flufenoxuron, hexaflumuron, lufenuron, novaluron, noviflumuron, penfluoron, teflubenzuron, triflumuron); juvenile hormone mimics (e.g., dayoutong, epofenonane, fenoxycarb, hydroprene, kinoprene, methoprene, pyriproxyfen, triprene); juvenile hormones (e.g., juvenile hormone I, juvenile hormone II, juvenile hormone III); moulting hormone agonists (e.g., chromafenozide, furan tebufenozide, halofenozide, methoxyfenozide, tebufenozide, yishijing); moulting hormones (e.g., a-ecdysone, ecdysterone); moulting inhibitors (e.g., diofenolan); precocenes (e.g., precocene I, precocene II, precocene III); unclassified insect growth regulators (e.g., dicyclanil)); nereistoxin analogue insecticides (e.g., bensultap, cartap, polythialan, thiocyclam, thiosultap); nicotinoid insecticides (e.g., flonicamid); nitroguanidine insecticides (e.g., clothianidin, dinotefuran, imidacloprid, imidaclothiz, thiamethoxam); nitromethylene insecticides (e.g., nitenpyram, nithiazine); pyridylmethylamine insecticides (e.g., acetamiprid, imidacloprid, nitenpyram, paichongding, thiacloprid); organochlorine insecticides (e.g., bromo-DDT, camphechlor,

DDT (e.g., pp′-DDT), ethyl-DDD, HCH (e.g., gamma-HCH, lindane), methoxychlor, pentachlorophenol, TDE); cyclodiene insecticides (e.g., aldrin, bromocyclen, chlorbicyclen, chlordane, chlordecone, dieldrin, dilor, endosulfan (e.g., alpha-endosulfan), endrin, HEOD heptachlor, HHDN, isobenzan, isodrin, kelevan, mirex), organophosphorus insecticides (e.g., organophosphate insecticides (e.g., bromfenvinfos, calvinphos, chlorfenvinphos, crotoxyphos, dichlorvos, dicrotophos, dimethylvinphos, fospirate, heptenophos, methocrotophos, mevinphos monocrotophos, naled, naftalofos, phosphamidon, propaphos, TEPP, tetrachlorvinphos); organothiophosphate insecticides (e.g., dioxabenzofos, fosmethilan, phenthoate); aliphatic organothiophosphate insecticides (e.g., acethion, acetophos, amiton, cadusafos, chlorethoxyfos, chlormephos, demephion (e.g., demephion-O, demephion-S), demeton (e.g., demeton-O, demeton-S), demeton-methyl (e.g., demeton-O-methyl, demeton-S-methyl), disulfoton, ethion ethoprophos, IPSP, isothioate, malathion, methacrifos, methylacetophos, oxydemeton-methyl, oxydeprofos, oxydisulfoton, phorate, sulfotep, terbufos, thiometon); aliphatic amide organothiophosphate insecticides (e.g., amidithion, cyanthoate, dimethoate, ethoate-methyl, formothion, mecarbam, omethoate, prothoate, sophamide, vamidothion), oxime organothiophosphate insecticides (e.g., chlorphoxim, phoxim, phoxim-methyl); heterocyclic organothiophosphate insecticides (e.g., azamethiphos, colophonate, coumaphos, coumithoate, dioxathion, endothion, menazon, morphothion, phosalone, pyraclofos, pyridaphenthion, quinothion); benzothiopyran organothiophosphate insecticides (e.g., dithicrofos, thicrofos); benzotriazine organothiophosphate insecticides (e.g., azinphos-ethyl, azinphos-methyl); isoindole organothiophosphate insecticides (e.g., dialifos, phosmet); isoxazole organothiophosphate insecticides (e.g., isoxathion, zolaprofos); pyrazolopyrimidine organothiophosphate insecticides (e.g., chlorprazophos, pyrazophos); pyridine organothiophosphate insecticides (e.g., chlorpyrifos, chlorpyrifos-methyl); pyrimidine organothiophosphate insecticides (e.g., butathiofos, diazinon, etrimfos, lirimfos, pirimioxyphos pirimiphos-ethyl, pirimiphos-methyl, primidophos, pyrimitate, tebupirimfos); thiadiazole organothiophosphate insecticides (e.g., athidathion, lythidathion, methidathion, prothidathion); triazole organothiophosphate insecticides (e.g., isazofos, triazophos); phenyl organothiophosphate insecticides (e.g., azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, xiaochongliulin)); phosphonate insecticides (e.g., butonate, trichlorfon); phosphonothioate insecticides (e.g., mecarphon); phenyl ethylphosphonothioate insecticides (e.g., fonofos, trichloronat); phenyl phenylphosphonothioate insecticides (e.g., cyanofenphos, EPN, leptophos); phosphoramidate insecticides (e.g., crufomate, fenamiphos, fosthietan, mephosfolan, phosfolan, phosfolan-methyl pirimetaphos); phosphoramidothioate insecticides (e.g., dimefox, mazidox, mipafox, schradan); oxadiazine insecticides (e.g., indoxacarb); oxadiazolone insecticides (e.g., metoxadiazone); phthalimide insecticides (e.g., dialifos, phosmet, tetramethrin); pyrazole insecticides (e.g., chlorantraniliprole, cyantraniliprole, dimetilan, isolan, tebufenpyrad, tolfenpyrad); phenylpyrazole insecticides (e.g., acetoprole, ethiprole, fipronil, pyraclofos, pyrafluprole, pyriprole, vaniliprole); pyrethroid insecticides (e.g., pyrethroid ester insecticides (e.g., acrinathrin, allethrin (e.g., bioallethrin, esdépalléthrine), barthrin, bifenthrin, bioethanomethrin
brofenvalerate, brofluthrinate, bromethrin, butethrin, chlorempenthrin, cyclethrin, cycloprothrin cyfluthrin (e.g., beta-cyfluthrin), cyhalothrin (e.g., gamma-cyhalothrin, lambda-cyhalothrin), cypermethrin (e.g., alpha-cypermethrin, beta-cypermethrin, theta-cypermethrin, zeta-cypermethrin), cyphenothrin, deltamethrin, dimefluthrin, dimethrin, empenthrin, d-fanshiluquebingjuzhi, fenfluthrin, fenpirithrin, fenpropathrin, fenvalerate (e.g., esfenvalerate), flucythrinate, fluvalinate (e.g., tau-fluvalinate), furamethrin, furethrin, imiprothrin, japothrins, kadethrin, meperfluthrin, methothrin, metofluthrin, pentmethrin, permethrin (e.g., biopermethrin, transpermethrin), phenothrin, prallethrin, profluthrin, proparthrin, pyresmethrin, resmethrin (e.g., bioresmethrin, cismethrin), tefluthrin, terallethrin, tetramethrin, tetramethylfluthrin, tralocythrin, tralomethrin, transfluthrin, valerate; pyrethroid ether insecticides (e.g., etofenprox, flufenprox,
halfenprox, protrifenbute, silafluofen); pyrethroid oxime insecticides (e.g., sulfoxime, thiofluoximate)); pyrimidinamine insecticides (e.g., flufenerim, pyrimidifen); pyrrole insecticides (e.g., chlorfenapyr); tetramic acid insecticides (e.g., spirotetramat); tetronic acid insecticides (e.g., spiromesifen); thiazole insecticides (e.g., clothianidin, imidaclothiz, thiamethoxam, thiapronil); thiazolidine insecticides (e.g., tazimcarb, thiacloprid); thiourea insecticides (e.g., diafenthiuron); urea insecticides (e.g., flucofuron, sulcofuron, see also chitin synthesis inhibitors); unclassified insecticides (e.g., closantel, copper naphthenate, crotamiton EXD, fenazaflor, fenoxacrim, hydramethylnon, isoprothiolane malonoben, metaflumizone, nifluridide, plifenate, pyridaben, pyridalyl, pyrifluquinazon, rafoxanide, sulfoxaflor, triarathene, triazamate).

In some embodiments, the active substance is an herbicide. Herbicides include, but are not limited to amide herbicides (e.g., allidochlor, amicarbazone, beflubutamid, benzadox, benzipram, bromobutide, cafenstrole, CDEA, cyprazole, dimethenamid (e.g., dimethenamid-P), diphenamid, epronaz, etnipromid, fentrazamide, flucarbazone, flupoxam, fomesafen, halosafen, huangcaoling, isocarbamid, isoxaben, napropamide, naptalam, pethoxamid, propyzamide, quinonamid, saflufenacil, tebutam); anilide herbicides (e.g., chloranocryl, cisanilide, clomeprop, cypromid, diflufenican, erlujixiancaoan, etobenzanid, fenasulam, flufenacet, flufenican, ipfencarbazone, mefenacet, mefluidide, metamifop, monalide, naproanilide, pentanochlor, picolinafen, propanil, sulfentrazone); arylalanine herbicides (e.g., benzoylprop, flamprop (e.g., flamprop-M)); chloroacetanilide herbicides (e.g., acetochlor, alachlor, butachlor, butenachlor, delachlor, diethatyl, dimethachlor, ethachlor, ethaprochlor, metazachlor, metolachlor (e.g., S-metolachlor), pretilachlor, propachlor, propisochlor, prynachlor, terbuchlor, thenylchlor, xylachlor); sulfonanilide herbicides (e.g., benzofluor, cloransulam, diclosulam, florasulam, flumetsulam, metosulam, perfluidone, pyrimisulfan, profluazol); sulfonamide herbicides (e.g., asulam, carbasulam, fenasulam, oryzalin, penoxsulam, pyroxsulam, see also sulfonylurea herbicides); thioamide herbicides (e.g., bencarbazone, chlorthiamid); antibiotic herbicides (e.g., bilanafos); aromatic acid herbicides (e.g., benzoic acid herbicides (e.g., chloramben, dicamba, 2,3,6-TBA, tricamba); pyrimidinyloxybenzoic acid herbicides (e.g., bispyribac, pyriminobac); pyrimidinylthiobenzoic acid herbicides (e.g., pyrithiobac); phthalic acid herbicides (e.g., chlorthal); picolinic acid herbicides (e.g., aminopyralid, clopyralid, picloram); quinolinecarboxylic acid herbicides (e.g., quinclorac, quinmerac)); arsenical herbicides (e.g., cacodylic acid, CMA, DSMA, hexaflurate, MAA, MAMA, MSMA, potassium arsenite, sodium arsenite); benzoylcyclohexanedione herbicides (e.g., ketospiradox, mesotrione, sulcotrione, tefuryltrione, tembotrione); benzofuranyl alkylsulfonate herbicides (e.g., benfuresate, ethofumesate); benzothiazole herbicides (e.g., benazolin, benzthiazuron, fenthiaprop, mefenacet, methabenzthiazuron); carbamate herbicides (e.g., asulam, carboxazole, chlorprocarb, dichlormate, fenasulam, karbutilate, terbucarb); carbanilate herbicides (e.g., barban, BCPC, carbasulam, carbetamide, CEPC, chlorbufam, chlorpropham, CPPC, desmedipham, phenisopham, phenmedipham, phenmedipham-ethyl, propham, swep); cyclohexene oxime herbicides (e.g., alloxydim, butroxydim, clethodim, cloproxydim, cycloxydim, profoxydim, sethoxydim, tepraloxydim, tralkoxydim); cyclopropylisoxazole herbicides (e.g., isoxachlortole, isoxaflutole); dicarboximide herbicides (e.g., cinidon-ethyl, flumezin, flumiclorac, flumioxazin, flumipropyn, see also uracil herbicides); dinitroaniline herbicides (e.g., benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin); dinitrophenol herbicides (e.g., dinofenate, dinoprop, dinosam, dinoseb, dinoterb, DNOC, etinofen, medinoterb); diphenyl ether herbicides (e.g., ethoxyfen); nitrophenyl ether herbicides (e.g., acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen); dithiocarbamate herbicides (e.g., dazomet, metam); halogenated aliphatic herbicides (e.g., alorac, chloropon, dalapon, flupropanate, hexachloroacetone, methyl bromide, methyl iodide, monochloroacetic acid, SMA, TCA); imidazolinone herbicides (e.g., imazamethabenz, imazamox, imazapic, imazapyr, imazaquin, imazethapyr); inorganic herbicides (e.g., ammonium sulfamate, borax, calcium chlorate, copper sulfate, ferrous sulfate, potassium azide, potassium cyanate, sodium azide, sodium chlorate, sulfuric acid); nitrile herbicides (e.g., bromobonil, bromoxynil, chloroxynil, dichlobenil, iodobonil, ioxynil, pyraclonil); organophosphorus herbicides (e.g. amiprofos-methyl, amiprophos, anilofos, bensulide, bilanafos, butamifos, 2,4-DEP, DMPA, EBEP, fosamine, glufosinate (e.g., glufosinate-P, glyphosate, huangcaoling piperophos); oxadiazolone herbicides (e.g., dimefuron, methazole, oxadiargyl, oxadiazon); oxazole herbicides (e.g., carboxazole, fenoxasulfone, isouron, isoxaben, isoxachlortole, isoxaflutole, methiozolin, monisouron, pyroxasulfone, topramezone); phenoxy herbicides (e.g., bromofenoxim, clomeprop, 2,4-DEB, 2,4-DEP, difenopenten, disul, erbon, etnipromid, fenteracol, trifopsime); phenoxyacetic herbicides (e.g., 4-CPA, 2,4-D, 3,4-DA, MCPA, MCPA-thioethyl, 2,4,5-T); phenoxybutyric herbicides (e.g., 4-CPB, 2,4-DB, 3,4-DB, MCPB, 2,4,5-TB); phenoxybutyric herbicides (e.g., 4-CPB, 2,4-DB, 3,4-DB, MCPB, 2,4,5-TB); phenoxypropionic herbicides (e.g., cloprop, 4-CPP, dichlorprop (e.g., dichlorprop-P), 3,4-DP, fenoprop, mecoprop (e.g., mecoprop-P); aryloxyphenoxypropionic herbicides (e.g., chlorazifop, clodinafop, clofop, cyhalofop, diclofop, fenoxaprop (e.g., fenoxaprop-P); fenthiaprop, fluazifop (e.g., fluazifop-P), haloxyfop (e.g., haloxyfop-P), isoxapyrifop, metamifop, propaquizafop, quizalofop (e.g., quizalofop-P), trifop); phenylenediamine herbicides (e.g., dinitramine, prodiamine); pyrazole herbicides (e.g., azimsulfuron, difenzoquat, halosulfuron, metazachlor, metazosulfuron, pyrazosulfuron, pyroxasulfone); pyrazole herbicides (e.g., benzofenap, pyrasulfotole, pyrazolynate, pyrazoxyfen, topramezone); phenylpyrazole herbicides (e.g., fluazolate, nipyraclofen, pinoxaden, pyraflufen); pyridazine herbicides (e.g., credazine, pyridafol, pyridate); pyridazinone herbicides (e.g., brompyrazon, chloridazon, dimidazon, flufenpyr, metflurazon, norflurazon, oxapyrazon, pydanon); pyridine herbicides (e.g., aminopyralid, cliodinate, clopyralid, diflufenican, dithiopyr, flufenican, fluoroxypyr, haloxydine picloram, picolinafen, pyriclor, pyroxsulam, thiazopyr, triclopyr); pyrimidinediamine herbicides (e.g., iprymidam, tioclorim);

pyrimidinyloxybenzylamine herbicides (e.g., pyribambenz-isopropyl, pyribambenz-propyl); quaternary ammonium herbicides (e.g., cyperquat, diethamquat, difenzoquat, diquat, morfamquat, paraquat); thiocarbamate herbicides (e.g., butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate); thiocarbonate herbicides (e.g., dimexano, EXD, proxan); thiourea herbicides (e.g., methiuron); triazine herbicides (e.g., dipropetryn, fucaojing, trihydroxytriazine); chlorotriazine herbicides (e.g., atrazine, chlorazine, cyanazine, cyprazine, eglinazine, ipazine, mesoprazine, procyazine, proglinazine, propazine, sebuthylazine, simazine, terbuthylazine, trietazine); fluoroalkyltriazine herbicides (e.g., indaziflam, triaziflam); methoxytriazine herbicides (e.g., atraton, methometon, prometon, secbumeton, simeton, terbumeton); methylthiotriazine herbicides (e.g., ametryn, aziprotryne, cyanatryn, desmetryn, dimethametryn, methoprotryne, prometryn, simetryn, terbutryn); triazinone herbicides (e.g., ametridione, amibuzin, ethiozin, hexazinone, isomethiozin, metamitron, metribuzin); triazole herbicides (e.g., amitrole, cafenstrole, epronaz, flupoxam); triazolone herbicides (e.g., amicarbazone, bencarbazone, carfentrazone, flucarbazone, ipfencarbazone, propoxycarbazone, sulfentrazone, thiencarbazone); triazolopyrimidine herbicides (e.g., cloransulam, diclosulam, florasulam, flumetsulam, metosulam, penoxsulam, pyroxsulam); uracil herbicides (e.g., benzfendizone, bromacil, butafenacil, flupropacil, isocil, lenacil, saflufenacil, terbacil); urea herbicides (e.g., benzthiazuron, cumyluron, cycluron, dichloralurea, diflufenzopyr, isonoruron, isouron, methabenzthiazuron, monisouron, noruron); phenylurea herbicides (e.g., anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron, thidiazuron); sulfonylurea herbicides (e.g., pyrimidinylsulfonylurea herbicides (e.g., amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, nicosulfuron, orthosulfamuron, oxasulfuron, primisulfuron, propyrisulfuron, pyrazosulfuron, rimsulfuron, sulfometuron, sulfosulfuron, trifloxysulfuron), triazinylsulfonylurea herbicides (e.g., chlorsulfuron, cinosulfuron, ethametsulfuron, iodosulfuron, metsulfuron, prosulfuron, thifensulfuron, triasulfuron, tribenuron, triflusulfuron, tritosulfuron)); thiadiazolylurea herbicides (e.g., buthiuron, ethidimuron, tebuthiuron, thiazafluoron, thidiazuron); unclassified herbicides (e.g., acrolein, allyl alcohol, aminocyclopyrachlor, azafenidin, bentazone, bentranil, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, dithioether, endothal, fluoromidine, fluridone, fluorochloridone, flurtamone, fluthiacet, indanofan, methoxyphenone, methyl isothiocyanate, OCH, oxaziclomefone, pelargonic acid, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan, tritac).

In some embodiments, the active substance is a fungicide. Fungicides include, but are not limited to aliphatic nitrogen fungicides (e.g., butylamine, cymoxanil, dodicin, dodine, guazatine, iminoctadine); amide fungicides (e.g., carpropamid, chloraniformethan, cyflufenamid, diclocymet, ethaboxam, fenoxanil, flumetover, furametpyr, isopyrazam, mandipropamid, penthiopyrad, prochloraz, quinazamid, silthiofam, triforine, xiwojunan); acylamino acid fungicides (e.g., benalaxyl (e.g., benalaxyl-M), furalaxyl, metalaxyl (e.g., metalaxyl-M), pefurazoate, valifenalate); anilide fungicides (e.g., benalaxyl (e.g., benalaxyl-M), bixafen, boscalid, carboxin, fenhexamid, fluxapyroxad, isotianil, metalaxyl (e.g., metalaxyl-M), metsulfovax, ofurace, oxadixyl, oxycarboxin, penflufen, pyracarbolid, sedaxane, thifluzamide, tiadinil, vangard); benzanilide fungicides (e.g., benodanil, flutolanil, mebenil, mepronil, salicylanilide, tecloftalam); furanilide fungicides (e.g., fenfuram, furalaxyl, furcarbanil, methfuroxam); sulfonanilide fungicides (e.g., flusulfamide); benzamide fungicides (e.g., benzohydroxamic acid, fluopicolide, fluopyram, tioxymid, trichlamide, zarilamid, zoxamide); furamide fungicides (e.g., cyclafuramid, furmecyclox); phenylsulfamide fungicides (e.g., dichlofluanid, tolylfluanid); sulfonamide fungicides (e.g., amisulbrom, cyazofamid); valinamide fungicides (e.g., benthiavalicarb, iprovalicarb); antibiotic fungicides (e.g., aureofungin, blasticidin-S, cycloheximide, griseofulvin, kasugamycin, moroxydine, natamycin, polyoxins, polyoxorim, streptomycin, validamycin); strobilurin fungicides (e.g., azoxystrobin, dimoxystrobin, enestroburin, fluoxastrobin, jiaxiangjunzhi, kresoxim-methyl, metominostrobin, orysastrobin, picoxystrobin, pyraclostrobin, pyrametostrobin, pyraoxystrobin, trifloxystrobin, xiwojunan); aromatic fungicides (e.g., biphenyl, chlorodinitronaphthalenes, chloroneb, chlorothalonil, cresol, dicloran, hexachlorobenzene, pentachlorophenol, quintozene, sodium pentachlorophenoxide, tecnazene); arsenical fungicides (e.g., asomate, urbacide); aryl phenyl ketone fungicides (e.g., metrafenone, pyriofenone); benzimidazole fungicides (e.g., benomyl carbendazim, chlorfenazole, cypendazole, debacarb, fuberidazole, mecarbinzid, rabenzazole, thiabendazole); benzimidazole precursor fungicides (e.g., furophanate, thiophanate, thiophanate-methyl); benzothiazole fungicides (e.g., bentaluron, benthiavalicarb, benthiazole, chlobenthiazone, probenazole); botanical fungicides (e.g., allicin, berberine, carvacrol, carvone, osthol); bridged diphenyl fungicides (e.g., bithionol, dichlorophen, diphenylamine, hexachlorophene, parinol); carbamate fungicides (e.g., benthiavalicarb, furophanate, iprovalicarb, propamocarb, pyribencarb, thiophanate, thiophanate-methyl); benzimidazolylcarbamate fungicides (e.g., benomyl, carbendazim, cypendazole, debacarb, mecarbinzid); carbanilate fungicides (e.g., diethofencarb, lvdingjunzhi, pyraclostrobin, pyrametostrobin); conazole fungicides (e.g., conazole fungicides (imidazoles) (e.g., climbazole, clotrimazole, imazalil, oxpoconazole, prochloraz, triflumizole, see also imidazole fungicides), conazole fungicides (triazoles) (e.g., azaconazole, bromuconazole, cyproconazole, diclobutrazol, difenoconazole, diniconazole (e.g., diniconazole-M), epoxiconazole, etaconazole, fenbuconazole, fluquinconazole, flusilazole, flutriafol, furconazole (e.g., furconazole-cis), hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, see also triazole fungicides)); copper fungicides (e.g., Bordeaux mixture, Burgundy mixture, Cheshunt mixture, copper acetate, copper carbonate, basic copper hydroxide, copper naphthenate, copper oleate, copper oxychloride, copper silicate, copper sulfate, copper sulfate, basic, copper zinc chromate, cufraneb, cuprobam, cuprous oxide, mancopper, oxine-copper, saisentong); cyanoacrylate fungicides (e.g., benzamacril, phenamacril); dicarboximide fungicides (e.g., famoxadone, fluoroimide); dichlorophenyl dicarboximide fungicides (e.g., chlozolinate, dichlozoline, iprodione, isovaledione, myclozolin, procymidone, vinclozolin); phthalimide fungicides (e.g., captafol, captan, ditalimfos, folpet, thiochlorfenphim); dinitrophenol fungicides (e.g., binapacryl, dinobuton, dinocap (e.g., dinocap-4, dinocap-6, meptyldinocap), dinocton, dinopenton, dinosulfon, dinoterbon, DNOC); dithiocarbamate fungicides (e.g., amobam, asomate, azithiram, carbamorph, cufraneb, cuprobam, disulfuram, ferbam, metam, nabam, tecoram, thiram, urbacide, ziram); cyclic dithiocarbamate fungicides (e.g., dazomet, etem, milneb); polymeric dithiocarbamate fungicides (e.g., mancopper, mancozeb, maneb, metiram, polycarbamate, propineb, zineb); dithiolane fungicides (e.g., isoprothiolane, saijunmao); fumigant fungicides (e.g., dithioether, methyl bromide); hydrazide fungicides (e.g., benquinox, saijunmao); imidazole fungicides (e.g., cyazofamid, fenamidone, fenapanil, glyodin, iprodione, isovaledione, pefurazoate, triazoxide, see also conazole fungicides (imidazoles)); inorganic fungicides (e.g., potassium azide, potassium thiocyanate, sodium azide, sulfur, see also copper fungicides, see also inorganic mercury fungicides); mercury fungicides (e.g., inorganic mercury fungicides (e.g., mercuric chloride, mercuric oxide, mercurous chloride), organomercury fungicides (e.g., (3-ethoxypropyl) mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate)); morpholine fungicides (e.g., aldimorph, benzamorf, carbamorph, dimethomorph, dodemorph, fenpropimorph, flumorph, tridemorph); organophosphorus fungicides (e.g., ampropylfos, ditalimfos, EBP, edifenphos, fosetyl, hexylthiofos, inezin, iprobenfos, izopamfos, phosdiphen, pyrazophos, tolclofos-methyl, triamiphos); organotin fungicides (e.g., decafentin, fentin, tributyltin oxide); oxathiin fungicides (e.g., carboxin, oxycarboxin); oxazole fungicides (e.g., dichlozoline, dingjunezuo, drazoxolon, famoxadone, hymexazol, metazoxolon, myclozolin, oxadixyl, vinclozolin); polysulfide fungicides (e.g., barium polysulfide, calcium polysulfide, potassium polysulfide, sodium polysulfide); pyrazole fungicides (e.g., bixafen, fluxapyroxad, furametpyr, isopyrazam, penflufen, penthiopyrad, pyraclostrobin, pyrametostrobin, pyraoxystrobin, rabenzazole, sedaxane); pyridine fungicides (e.g., boscalid, buthiobate, dingjunezuo, dipyrithione, fluazinam, fluopicolide, fluopyram, lvdingjunzhi, parinol, pyribencarb, pyridinitril, pyrifenox, pyroxychlor, pyroxyfur); pyrimidine fungicides (e.g., bupirimate, diflumetorim, dimethirimol, ethirimol, fenarimol, ferimzone, nuarimol, triarimol); anilinopyrimidine fungicides (e.g., cyprodinil, mepanipyrim, pyrimethanil); pyrrole fungicides (e.g., dimetachlone, fenpiclonil, fludioxonil, fluoroimide); quinoline fungicides (e.g., ethoxyquin, halacrinate, 8-hydroxyquinoline sulfate, quinacetol, quinoxyfen, tebufloquin); quinone fungicides (e.g., benquinox, chloranil, dichlone, dithianon); quinoxaline fungicides (e.g., chinomethionat, chlorquinox, thioquinox); thiazole fungicides (e.g., ethaboxam, etridiazole, isotianil, metsulfovax, octhilinone, thiabendazole, thifluzamide); thiazolidine fungicides (e.g., flutianil, thiadifluor); thiocarbamate fungicides (e.g., methasulfocarb, prothiocarb); thiophene fungicides (e.g., ethaboxam, silthiofam); triazine fungicides (e.g., anilazine); triazole fungicides (e.g., amisulbrom, bitertanol, fluotrimazole, huanjunzuo, triazbutil, see also conazole fungicides (triazoles)); triazolopyrimidine fungicides (e.g., ametoctradin); urea fungicides (e.g., bentaluron, pencycuron, quinazamid); unclassified fungicides (e.g., acibenzolar, acypetacs, allyl alcohol, benzalkonium chloride, bethoxazin, bromothalonil, chloropicrin, DBCP, dehydroacetic acid, diclomezine, diethyl pyrocarbonate, ethylicin, fenaminosulf, fenitropan, fenpropidin, formaldehyde, furfural, hexachlorobutadiene, methyl iodide, methyl isothiocyanate, nitrostyrene, nitrothal-isopropyl, OCH, 2-phenylphenol,

phthalide, piperalin, propamidine, proquinazid, pyroquilon, sodium orthophenylphenoxide, spiroxamine, sultropen, thicyofen, tricyclazole, zinc naphthenate).

In some embodiments, the active substance is a plant growth regulator. Plant growth regulators include but are not limited to antiauxins (e.g., clofibric acid, 2,3,5-tri-iodobenzoic acid); auxins (e.g., 4-CPA, 2,4-D, 2,4-DB, 2,4-DEP, dichlorprop, fenoprop, IAA, IBA, naphthaleneacetamide, a-naphthaleneacetic acid, 1-naphthol, naphthoxyacetic acids, potassium naphthenate, sodium naphthenate, 2,4,5-T); cytokinins (e.g., 21P, benzyladenine, 4-hydroxyphenethyl alcohol, kinetin, zeatin); defoliants (e.g., calcium cyanamide, dimethipin, endothal, ethephon, merphos, metoxuron, pentachlorophenol, thidiazuron, tribufos); ethylene inhibitors (e.g., aviglycine, 1-methylcyclopropene); ethylene releasers (e.g., ACC, etacelasil, ethephon, glyoxime); gibberellins (e.g., gibberellins, gibberellic acid); growth inhibitors (e.g., abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, 2,3,5-tri-iodobenzoic acid); morphactins (e.g., chlorfluren, chlorflurenol, dichlorflurenol, flurenol); growth retardants (e.g., chlormequat, daminozide, flurprimidol, mefluidide, paclobutrazol, tetcyclacis, uniconazole); growth stimulators (e.g., brassinolide, brassinolide-ethyl, DCPTA, forchlorfenuron, hymexazol, prosuler, pyripropanol, triacontanol); unclassified plant growth regulators (e.g., bachmedesh, benzofluor, buminafos, carvone, ciobutide, clofencet, cloxyfonac, cyanamide, cyclanilide, cycloheximide, cyprosulfamide, epocholeone, ethychlozate, ethylene, fenridazon, fuphenthiourea, furalane, heptopargil, holosulf, inabenfide, karetazan, lead arsenate, methasulfocarb, prohexadione, pydanon, sintofen, triapenthenol, trinexapac).

In some embodiments, the particular temperature is between 5° C. and 90° C. (e.g., 10° C. . . . 20° C. . . . 30° C. . . . 40° C. . . . 50° C. . . . 60° C. . . . 70° C. . . . 80° C. . . . or 90° C.). In other embodiments, the particular temperature is between 10° C. and 60° C. In other embodiments, the particular temperature is between 20° C. and 45° C. In further embodiments, the active substance in the liquid is not microencapsulated. In particular embodiments, the composition is free or substantially free from reagents used to form microcapsules. In additional embodiments, the composition is free or substantially free of vapor pressure management reagents other than the solvent. In further embodiments, the composition is free or substantially free of reagents, other than the solvent, capable of preventing or reducing vapor transfer of the active substance from a first surface to a second surface. In some embodiments, the vapor pressure control systems and methods described herein are used in combination with other volatility control systems and methods (e.g., micro-encapsulation).

In some embodiments, the present invention provides systems comprising: a) a device configured to spray liquid onto a surface; and b) any of the compositions described above or below. In certain embodiments, the composition is located within the device. In further embodiments, the device comprises an agricultural implement. In particular embodiments, the device is a herbicide spraying device. In other embodiments, the device is a pesticide spraying device.

In certain embodiments, the present invention provides systems comprising: a) a device configured to spray liquid onto a surface; and b) any of the compositions or mixtures described above or below.

In some embodiments, the present invention provides systems comprising: a) a target substrate, and b) a composition comprising: i) a liquid, gas, and/or solid comprising an active substance, and ii) a solvent that reduces or inhibits vapor transfer of the active substance to non-target substrates adjacent to the target substrate. In further embodiments, the composition is present on the target substrate. In other embodiments, the composition is present on the target substrate and the liquid is not detectably present on the non-target substrate.

In particular embodiments, the present invention provides methods comprising: a) providing a composition comprising: i) any of the compositions or mixtures described above or below, and b) applying the composition to the first surface. In some embodiments, the applying is under conditions such that no detectable amount of the liquid in the composition is vapor transferred to the second surface at the particular temperature.

In particular embodiments, the present invention provides methods comprising: a) providing any of the compositions or mixtures described above or below, and b) applying the composition to a first surface such that no detectable amount of the liquid in the composition is vapor transferred to a second surface at the particular temperature.

In certain embodiments, the first surface comprises: i) an agricultural crop not killed or injured by the composition, and ii) undesirable plants killed or injured by the composition. In other embodiments, the second surface comprises desirable agricultural crops injured or killed by the liquid in the composition. In some embodiments, applying the composition is accomplished using a device configured to spray liquid onto a surface. In further embodiments, the device comprises an agricultural implement. In additional embodiments, the device is a herbicide or pesticide spraying device.

In some embodiments, the present invention provides methods comprising: mixing a liquid with a solvent to generate a mixture, wherein the liquid comprises an active substance and has a first vapor pressure at a particular temperature prior to the mixing, and wherein the mixture has a second vapor pressure at the particular temperature that is lower than the first vapor pressure.

In particular embodiments, the methods further comprise mixing the mixture and an emulsifying solution under conditions such that an emulsified composition results, wherein the emulsifying solution comprises water and an emulsifier. In other embodiments, the conditions comprise blending the composition and the emulsifying solution at a high rate of speed. In other embodiments, the methods further comprise mixing the mixture and an emulsifyer under conditions such that an emulsifiable concentrate results. In other embodiments, the emulsifiable concentrate is added to water to form an emulsified composition. In particular embodiments, the mixing is under conditions such that the mixture is in the form of a foam. In further embodiments, an adjuvant or additional active substance is added to the liquid prior, during, or after the formation of the foam. In certain embodiments, the methods further comprise the step of combining the composition with dispersible granules.

In some embodiments, mixtures of active substances and solvents or other materials may further be formulated as a mixture with any one or more components to produce a desired formulation.

In some embodiments, one or more components is added or conditions are changed to alter the viscosity so as to alter the vapor pressure. In some embodiments, a high viscosity material (e.g., solvent) is used. In some embodiments, viscocity modification is employed where low viscocity solvents are used.

In some embodiments, the present invention provides methods for manufacturing and shipping active substances. The “manufacturing use product” (MUP) or the “ready to use” (RTU) form is often shipped from the production facility in one region (e.g., country) to another region where the product formulation is “completed”. “Completed” may mean adding more ingredients or simply diluting the mix. The shipment of the intermediate is common for several reasons: reducing supply chain cost (e.g., shipping less water), lack of understanding of local packaging and labeling standards where the product is manufactured, and lack of physical product stability. In some embodiments, the MUP or the RTU is stabilized from a volatility standpoint using embodiments of the invention so that when compared to shipping an unstable “pure” technical grade, more of the useful form of the compound reaches its final location. Then, in some embodiments, the final dilution (final formulation) is prepared at the destination, saving some of the supply chain cost of shipping totally finished goods. Thus, in some embodiments, active substances are formulated with the solvent or other material at a manufacturing location and shipped in mixed form (e.g., solvated active substance, power, granules, etc.). The mixed form may be RTU or may be provided in a manner that requires dilution or some other form of preparation by the seller, end user, or retailer. In some embodiments, the materials are partially prepared at the manufacturing location and shipped to a retailer or customer. The final preparations are prepared by the retailer or customer. For example, an active substance may be mixed with a solvent, but not made into final emulsified or granulized form until after shipment. In other embodiments, the components of the final product are prepared in a kit form by the manufacture and are assembled by the end user or retailer. For example, a kit may contain the active substance, a solvent, and/or other formulation materials in separate containers. Likewise, a kit may provide a subset of these materials with the intention that missing components will be acquired separately and combined by the end user or retailer.

It is contemplated that the formulations described herein provide one or more advantages for the manufacture, shipment, handling, and/or use of active substance: odor containment, controlled volatility, improved stability, and reduction in exposure to humans or animals (e.g., exposure to skin, mucosal surfaces, lungs, eyes, wounds, etc.).

### DETAILED DESCRIPTION

The present invention provides compositions, systems, and methods employing materials (e.g., solvents) to reduce or eliminate vapor transfer of an active substance from a target surface to a non-target surface. In certain embodiments, a material (e.g., solvent) is mixed with a liquid, gas or solid comprising an active substance to form a mixture such that the mixture has a lower vapor pressure than the liquid, gas, and/or solid. In some embodiments, the active substance is a herbicide or pesticide and the target surface is an agricultural field or crop.

The present invention relates to formulations of active substances, such as volatile compounds, having reduced volatility relative to conventional formulations (emulsifiable concentrates, aqueous solutions, etc.). This reduced volatility inhibits or eliminates vapor transfer or “drift” to non target surfaces (e.g., plants).

In certain embodiments, the solvents, when mixed with an active substance (e.g., unstable or volatile substance) reduces the hydrolysis of the active substance. In such cases, the solvents and mixtures of the present invention serve to preserve the activity of the active substance (e.g., during storage or during transport).

As indicated above, the present invention is not limited to any particular active substance that is mixed with the solvent. To illustrate certain embodiments of the invention, use with certain specific active agents are described below. It will be understood that the principles outlined below can be applied to a variety of active agents and applications. In certain embodiments, the active substance is clomazone or a clomazone derivative. Clomazone is a herbicidally active oxazolidinone, with the IUPAC name 2-(2-chlorobenzyl)-4,4-dimethyl-1,2-oxazolidin-3-one, represented by the following structure.

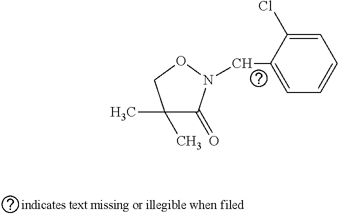

In the Chemical Abstracts Service (CAS) system, it is known by the name 2-[(2-chlorophenyl)methyl]-4,4-dimethyl-3-isoxazolidinone, and assigned a unique registry number of 81777-89-1. Clomazone and derivatives of clomazone are described by the following formula:

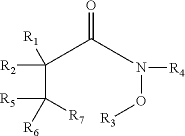

wherein R1 and R2 are the same or different C1-C4 alkyl; R3 is hydrogen, C1-C4 alkyl, C7-C14 aralkyl, pyranyl, tert-butyl-dimethylsilyl, or

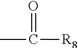

in which R8 is alkyl, aryl, amino, alkyl- or aryl substituted amino, alkoxy, phenoxy, alkylthio, arylthio, halo-substituted alkyl, and any aryl may be halo-, methyl-, methoxy-, nitro-, amino-, or CF3-substituted;

R4 is hydrogen, alkyl, phenyl,

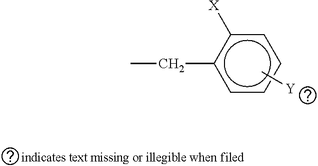

in which X is hydrogen, halogen, C1-C4 alkyl, phenyl, and Y is halogen, —CF3, C1-C4 alkyl, nitro, methoxy, methylenedioxy, and n is 0, 1, or 2;

R5 is hydrogen, halogen, alkyl, aryl, alkoxy, aryloxy, alkylthio, arylthio, amino, alkyl-substituted amino, OH or its derivatives (including but not limited to acetate, benzoate, tosylate, or carbamate), or with R1 forms a ring;

R6 is hydrogen, halogen, alkyl, aryl, alkoxy, aryloxy, alkylthio, arylthio, amino, alkyl-substituted amino, OH or its derivatives (including but not limited to acetate, benzoate, tosylate, carbamate);

R7 is hydrogen, or halogen;

and R3 and R7 may comprise a single carbon-oxygen bond, forming a ring structure.

In certain embodiments, R1 and R2 are methyl, ethyl; R4 is

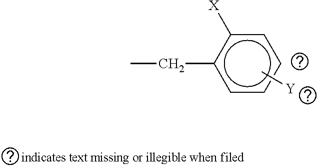

R5 and R6 are hydrogen, chlorine, bromine, methoxy.

In other embodiments, R4 is

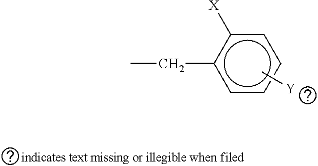

are those in which X is 2-chloro, 2-bromo, 2-fluoro, and Y is 4-chloro, 4-bromo, 4-F, 5-F, and 4,5-methylenedioxy, and n is 0 or 1.

In particular embodiments, R1 and R2 are methyl; R3 and R7 are hydrogen or comprise a single carbon-oxygen bond, forming a ring structure.

Clomazone is soluble in most organic solvents, and that fact is used to advantage to provide for a microencapsulation matrix in emulsion polymerization techniques. The microencapsulation literature describes the need for a high boiling solvent (boiling pt.>170° C.) such as AE-700 or edible oils (see Anderson U.S. Pat. No. 5,783,520), a commercial solvent for use in emulsion polymerization encapsulation of clomazone. However, the art teaches that, as part of the preparation of an aqueous emulsion and subsequent emulsion, polymerization based microencapsulation of the product is required. As mentioned above, the current commercial formulation of clomazone, Command 3ME (FMC Corporation) is such a microencapsulated product. Thus, literature does not describe that edible oils or oils of similarly low vapor pressure, when used in, for example, emulsion concentrate formulations, will provide vapor transfer reduction relative to existing emulsion concentrates without microencapsulation.

In certain embodiments, the active substance comprises an organophosphate, such as the insecticide malathion, dimethoate, or chlorpyrifos. Methods of making malathion are described in the patent literature including U.S. Pat. Nos. 2,578,652; 3,463,841; 4,367,180; and 4,929,608, all of which are herein incorporated by reference.

Work conducted during the development of embodiments of the present invention led to the surprising discovery that given a solvent or other material of sufficiently low vapor pressure (or relatively low compared to the active substance liquid), simple, non-encapsulated formulations of active substances (e.g., clomazone) can be prepared that do not exhibit the expected drift, without the need for additional microencapsulation. This provides many formulation advantages relative to microencapsulation. For example, the active substance (e.g., clomazone or malathion) may be formulated as a simple oil in water emulsion, emulsifiable concentrate, or even as a simple solution in the selected solvent. Soybean oil is an example of such a solvent, but acceptable solvents also include edible or vegetable oils, as well as solvent that has a sufficiently low vapor pressure to prevent drift (e.g., in field applications). In field applications, the commonly used commercial solvents such as AE-700, or AE-150, allowed for sufficient volatilization of clomazone to cause vapor transfer injury to non target crops, yet soybean oil, or any sufficiently low vapor pressure solvent inhibits or prevents this phenomenon, while still allowing diffusion controlled release of clomazone from the oil to the target, thereby maintaining efficacy of the product. Thus, the advantage of low vapor transfer of the current microencapsulated COMMAND 3ME formulation is maintained, yet the disadvantage of reduced efficacy due to permeation across a microcapsule wall is mitigated or eliminated.

In certain embodiments, the present invention provides formulations that include, but are not limited to, neat solutions of clomazone or other active substance in solvent, emulsifiable concentrates of clomazone or other active substance using said solvent as a carrier, and emulsions in which clomazone or other active substance is dispersed in the solvent prior to emulsification. Other formulation approaches may be employed, such as liposomal encapsulation of clomazone or other active substance in such low vapor pressure solvents, microemulsions of clomazone or other active substances incorporated into low vapor pressure solvents, and foams of active substance/solvent mixtures. In some embodiments, granular or other dry formulations are employed.

In aqueous emulsion or foam embodiments, other components such as adjuvants and/or other active substance (e.g., herbicides) may be added to the aqueous phase either during or after preparation of the emulsion or foam. In the case of emulsifiable concentrates, such adjuvant and/or active substance mixtures may be added during or after dispersion of the concentrate in water.

While the present invention is not limited to any particular mechanism, and an understanding of the mechanism is not necessary to understand or practice the present invention, it is believed that the nature of clomazone vapor transfer to non-target crops (drift) has not been fully understood in the literature, and that the drift occurs not only because of the relatively high vapor pressure of clomazone itself, but because the vapor pressure of the carrier solvents used to date may permit a psuedo-distillation of clomazone into the atmosphere, where it can be carried to the surrounding environment. This is consistent with observations that drift typically occurs under conditions of high heat and humidity, which may allow for a variant of “steam distillation” of clomazone. This working hypothesis in no way limits the scope of the invention, and the invention result is surprising regardless of the actual mechanism of vapor transfer reduction.

### EXAMPLES

The following examples are presented in order to provide certain exemplary embodiments of the present invention and are not intended to limit the scope thereof.

### Example 1

### Formulation of Clomazone as a Simple Emulsion

A 1:1 solution of clomazone in soybean oil was prepared by dissolving 15.0 g of clomazone in 15.0 g of soybean oil. Subsequently, 0.17 g lecithin (Centrolex F) and 7.02 g deionized water were added to a 20 ml vial, and the lecithin/water mixture was sonicated for 1 minute 26 seconds at 50-70% power, using a Fisher Scientific Sonic Dismembrator with a model CL4 ultrasonic converter equipped with a ½ inch horn. The resulting nearly transparent lecithin dispersion was resonicated for 1 minute 49 seconds while 2.15 g of the 1:1 clomazone:soybean oil solution was added. This resulted in an opaque, white emulsion. The composition of this emulsion was 1.82% lecithin, 11.51% soybean oil, and 11.51% clomazone, by weight. The particle size of this emulsion was between 220 nm and 2 microns, and the product was stable for over a year as measured by the standard EPA accelerated formulation aging study. The product was stable for at least 3 months storage at 54 C (which is considered an equivalent of a two year aging process). A dilution of this emulsion (1:99) in water was similarly stable, demonstrating outstanding stability for tank mix applications.

### Example 2

### Formulation of Clomazone as an Emulsifiable Concentrate

Toximul 8242 (Steppan, 0.41 g), Toximul TA-5 (Steppan, 0.1 g), Atlox 4838B (Croda, 0.91 g), and a 1:1 mixture of clomazone:soybean oil (8.62 g) were combined in a beaker and mixed by simple shaking, resulting in a clear solution of 4.0% Toximul 8242, 1.0% Toximul TA-5, 8.8% Atlox 4838B, 43.1% soybean oil and 43.1% clomazone. When 1.0 ml of this concentrate was added to 99.0 ml of water in a capped 100 ml graduated cylinder, and the cylinder was inverted three times, a cloudy white oil in water emulsion was produced. After 24 hours standing, some settling occurred, but a simple, single re-inversion of the graduated cylinder restored the emulsion with ease.

### Example 3

### Emulsfiable Concentrate Formulation

An emulsifiable concentrate was prepared by admixture of Synperonic A4 (0.15 g), Synperonic A20 (0.26 g), Atlox 4838B (0.50 g), Atlas G-5000 (0.10 g) and a 1:1 clomazone:soybean oil solution (9.01 g) resulting in an emulsifiable concentrate composed of 1.5% Synperonic A4, 2.5% Synperonic A20, 5.0% Atlox 4838B, 1.0% Atlas G5000, 45.0% soybean oil and 45.0% clomazone. As in Example 2, the resultant emulsifiable concentrate readily dispersed in water, and re-suspended, although this sample exhibited slightly more settling upon standing.

### Example 4

### Emulsifiable Concentrate at Lower Clomazone Concentration

Toximul 8242 (261.5 g), Toximul TA-5 (65.4 g), Atlox 4838 B (575.5 g), soybean oil (3063.5 g), and clomazone (2033.9 g) were mixed in a large beaker with magnetic stirring, resulting in an emulsifiable concentrate containing 31.1% clomazone and 55.5% soybean oil. This concentrate had outstanding characteristics upon dilution, as in Example 1. This material was applied in to rice crops in with drift results comparable to or lower than that of control plots on which a comparable amount of a commercially available micro-encapsulated clomazone formulation “COMMAND 3ME” had been applied. Additional field testing demonstrated significant herbicidal activity at ⅔ the dosage rate specified by the label of the commercial product. Finally, it was determined that the test material was easier to handle than the commercial product in that there was far less sedimentation subsequent to dilution, resulting in improved, more uniform transfer from the spray tank to the target weeds.

### Example 5

### Malathion Formulations

Formulations of malathion and soybean oil were also made, and then these formulations were tested as in Example 4. The results of this testing were positive as the use of the solvent reduced vapor drift in field testing.

### Example 6

### Clomazone Volatility in Emulsifiable Concentrate vs COMMAND 3ME

A sample similar to that of Example 4 was prepared (31.1% clomazone, equivalent to the amount found in COMMAND 3ME). Both this sample and COMMAND 3ME were subject to GC headspace analysis. In particular, the following GC conditions were used: Restek RTX-1 15M 0.25 mm Capillary column; Temperature program: 130° C. hold 0.5 minutes, 10° C. per minute, and 200° C. hold for 5 minutes; injector temp 240° C.; Injector Split/Splitless; and Detector FID. Ten (10) grams of each test formulation was added to a 40 milliliter headspace jar fitted with a screw top cap with a rubber septum. Each jar was placed into a 40° C. water bath and incubated for 1 hour. A 250 microliter gas sample was taken from each jar and injected into the GC. The clomazone peak was determined to elute under these chromatographic conditions in ˜5.7 minutes. The areas under the clomazone peak determined and the average areas compared relative to the average COMMAND 3ME peak areas. Table 1 presents the results of this analysis:

TABLE 1

| | Clomazone | | |
|---|---|---|---|
| Sample ID | Peak Area | Average | Relative Area |
| COMMAND 3ME | 76.40656 | 72.20736 | 100.0% |
| | 75.50072 | | |
| | 64.71481 | | |
| 31.1% clomazone EC | 71.25714 | 64.21066 | 88.9% |
| | 63.67119 | | |
| | 57.70364 | | |

Based on the above findings, it was concluded that the soybean oil emulsifiable concentrate formulation releases an amount of clomazone vapor less than that provided by the commercially available microencapsulated COMMAND 3ME.

### Example 7

### Greenhouse Evaluation

Annual rye grass was grown in the greenhouse in plastic pots to a height of ˜5 inches. The grass was then clipped back to a height of 3 inches and allowed to grow again to a height of 5 inches. Six (6) pots of grass were placed at various locations in the greenhouse and all other growing plants were removed from the greenhouse.

COMMAND 3ME was diluted in water resulting in a solution containing 3% of the formulation. The diluted material was sprayed on to a flat of damp soil with a surface area of ˜2 square feet. The treated flat was immediately placed in the greenhouse and placed on a rack closest to the door. The temperature of the greenhouse is maintained at ˜80° C. and the humidity was determined to remain between 30% and 40%.

The greenhouse was sealed and only opened daily to take plant injury readings and to water the plants. The plants were watered by carefully adding water to only the soil and not to any of the foliage. The study was run for 4 days. During that time no chlorosis or wilting of the grass was observed.

The above study was repeated using applications of the emulsion concentrate formulation described in Example #6 above. New grass samples and fresh untreated soil was used. As with the COMMAND 3ME, no chlorosis or wilting of the plant material was observed.

The study was again repeated using the 3EC formulation of Clomazone which is similar to the EC formulation which had been previously commercialized by FMC, but later supplanted by COMMAND 3ME. One day after application, moderate chlorosis was observed on the adjacent grass pots and slight chlorosis was observed on the pot farthest away from the treated soil. After 4 days all pots showed severe chlorosis. The results indicate that the clomazone:soybean oil formulation that does not contain microencapsulating agents is a low volatility solvent formulation that inhibits clomazone volatility and drift in a manner comparable to or superior to the inhibition provided by commercially available COMMAND 3ME, and in far superior fashion to the previously available emulsifiable concentrates.

### Example 8

### VOC and Viscosity Examples

In support of the GC data obtained (and listed in example 6), the following samples were analyzed for volatile organic content (VOC) by the TGA method employed by the California Department of Pesticide Registration, (Attachment B, Method Date: Feb. 9, 2005, web site for cdpr.ca.gov, subdirectory at docs/emon/vocs/vocproj/tga_method.pdf.

| Sample | VOC % | Viscosity (cP) |
|---|---|---|
| Command 4EC | 33.17 | <2 |
| Command 3ME | 14.76 | solid capsule-N/A |
| Embodiment | 8.92 | 55 |

*N/A—measurement not applicable

Command 4EC is the original FMC product, which exhibited significant drift in the field. As expected, the encapsulated version of this product (Command 3ME), has a lower VOC content, accounting for its reduced drift. An embodiment of the invention, “Embodiment” prepared as described in Example 4, prepared at the same concentration of active ingredient as Command 3ME, has yet a lower VOC. Also, the principal carrier for Embodiments has a viscosity of between 55-66 cP, whereas that for Command 4EC has a viscosity <2 cP. Thus, diffusion of the active ingredient is inhibited via embodiments of the invention, further reducing the observable VOC, and the observable drift. Reduction of diffusion is preferable to encapsulation because release of the active ingredient is no longer dependent upon physical degradation of the capsule.

### Example 9

### Demonstration of Reduced Vapor Pressure at 120 Degrees Centigrade

In addition to the above data, the vapor pressure of clomazone in soybean oil and Command 4EC were measured with a Minivap vapor pressure unit (120 C), both at 48% active ingredient concentration.

| Sample | Vapor Pressure (psi) |
|---|---|
| Command 4EC | 0.47 |
| Embodiment | 0.11 |

(Average of 5 measurements, Standard Deviation <= 0.02)

This data shows that the vapor pressure of clomazone is greatly reduced using embodiments of the present invention.

### Example 10

### Formulation of Clomazone in Low Vapor Pressure Solids

### Formulation 1:

Polyethylene glycol (17.81 g) of average molecular weight 8000 (Sigma P-4463, Lot30K0232, “polyethlene glycol, av. mol. wt 8000) was melted with a heat gun (˜80 degrees centrigrade), and clomazone (2.19 g, purity=91.5%) was added. The viscous mixture was stirred to uniformity while still hot. The mixture was then cooled to room temperature, resulting in a solid mass which was ground with a mortar and pestle to a fine, flowable powder. This material contained 10% clomazone (purity adjusted) in PEG-8000.

### Formulation 2:

The same experiment was done with the exception that a lower molecular weight polyethylene glycol (av. mol. wt.=3350) was used as the carrier. This material, again a fine flowable powder, contained 10% clomazone (purity adjusted) in PEG-3350.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1.-80. (canceled)

81. A composition comprising a mixture of: i) a solvent, and ii) a liquid gas and/or solid comprising an agriculturally active substance, wherein said solvent has a vapor pressure that is sufficiently lower than said liquid gas, and/or solid, such that when the two are mixed, vapor transfer of said liquid gas and/or solid to non-target crops is greatly reduced, or even eliminated.

82. The composition of claim 81, wherein said solvent reduces or eliminates vapor transfer of a pesticide, herbicide, insecticide, fungicide, or plant growth regulator active ingredient from a target crop to a non-target crop.

83. The composition of claim 81, in the form of an emulsion or emulsifiable concentrate.

84. The composition of claim 81, in the form of a liquid, solid, solid at room temperature, or foam.

85. The composition of claim 81, wherein said solvent has a vapor pressure that is at least 2-4 times lower than said first vapor pressure of said liquid, gas or solid.

86. The composition of claim 81, wherein said solvent comprises an oil selected from synthetic or natural triglycerides, paraffins, vegetable oils, soybean oil or animal oils.

87. The composition of claim 81, wherein said agriculturally active substance is selected from the group: acetochlor, alachlor, asulam, butachlor, diethatyl, diflufenican, dimethenamid, flamprop, metazachlor, metolachlor, pendimethalin, pretilachlor, propachlor, propanil, trifluralin, aminopyralid, chloramben, clopyralid, dicamba, picloram, pyrithiobac, quinclorac, quinmerac, cacodylic acid, copper arsenate, DSMA, MSMA, bensulide, bilanafos, ethephon, fosamine, glufosinate, glyphosate, piperophos, 2,4-D, 2,4-DB, dichlorprop, fenoprop, MCPA, MCPB, 2,4,5-T, dithiopyr, malathion, parathion, fluoroxypyr, imazapyr, thiazopyr, triclopyr, diquat, MPP, paraquat, ametryn, atrazine, cyanazine, hexazinone, prometon, prometryn, propazine, simazine, simetryn, terbuthylazine, terbutryn, chlortoluron, DCMU, metsulfuron-methyl, 3-AT, bromoxynil, clomazone, DCBN, dinoseb, juglone, methazole, metham sodium, sulfentrazone, and/or combinations thereof.

88. The composition of claim 81, wherein said agriculturally active substance is not microencapsulated.

89. The composition of claim 81, wherein said solvent comprises triglycerides comprising:
a) i) about 50-65% poly un-saturated fatty acids, ii) about 18-30% mono-unsaturated fatty acids, and iii) about 10-20% saturated fatty acids;
b) i) about 55-60% poly un-saturated fatty acids, ii) about 20-25% mono-unsaturated fatty acids, and iii) about 12-17% saturated fatty acids;
c) i) about 45-55% linoleic acid, ii) about 20-30% oleic acid, iii) about 3-10% linolenic acid, iv) about 1-8% stearic acid, and v) about 5-15% palmitic acid; or
d) i) about 49-53% linoleic acid, ii) about 21-25% oleic acid, iii) about 5-9% linolenic acid, iv) about 2-6% stearic acid, and v) about 8-12% palmitic acid.

90. The composition of claim 81, wherein said composition is formulated with solid material.

91. The composition of claim 81, wherein said composition is free or substantially free of microcapsules or reagents used to form microcapsules.

92. A system comprising: a) a device configured to spray liquid onto a surface; and b) a composition of claims 1.

93. The system of claim 92, wherein said composition is located within said device.

94. A method comprising: applying the composition of claim 1 to a surface.

95. The method of claim 94, wherein said surface is an agricultural crop.
